(19) United States
(12) Patent Application Publication
(10) Pub. No.: US 2007/0150336 A1
(43) Pub. Date: Jun. 28, 2007

(54) System and method for controlling passage through a gate of a parking lot

(76) Inventor: Daniel Boily, Verdun (CA)

Correspondence Address: Franz Bonsang;c/o PROTECTIONS EQUINOX INT'L INC., Suite 224, 4480, Cote-de-Liesse, Montreal, QC, H4N 2R1, CA

(21) Appl. No.: 11/313,931

(22) Filed: Dec. 22, 2005

(51) Int. Cl. G07B 15/00

(52) U.S. Cl. 705/13

(57) ABSTRACT

A system and method for controlling movement of gate of a parking lot provides an access document reading means for reading an access identifier of an access document of customer. The access identifier is transmitted from access control device to a lot control device which consults a database in which access identifier identifies access rights assigned to customer and defining customer's right to pass through gate. Based on access rights, lot control device controls movement of gate to control passage of customer therethrough in a vehicle. Access documents and access rights may be obtained by use of computing devices connected to lot control device by an Internet network. Further, images of parking lot are captured by cameras for security and surveillance purposes and are viewable from computing devices. Telephone communication between customer and an attendant of parking lot are also provided.

### FIELD OF THE INVENTION

The present invention relates to automated parking lot management systems, and is more particularly concerned with a system and method for controlling passage through a gate at en entry or exit for a parking lot.

### BACKGROUND OF THE INVENTION

It is well known in the art to use computer technology, computing devices and networks in systems and methods to manage toll parking lots, and in particular to control passage of a customer in a vehicle through a gate of a parking lot. For example, US patent application US2003/0004792 discloses a system for controlling access to a parking lot using computing devices and a network to control a gate to permit or deny customers to pass therethrough to use the parking lot. However, most such systems and methods require, to install the network, purchase of new and additional components compatible with the computing devices, as well as purchase and installation of wiring adapted to be used with computing devices and other components of system.

To circumvent this problem, some systems and methods for parking lots have adopted use of Echelon® networks, using Echelon® Neuron® microprocessors and connectors provided by Echelon® corporation of San Jose, Calif. Echelon® networks typically allow connection of many different types of devices, for control thereof, to computing devices by using existing and/or inexpensive cabling, such as twisted pairs of copper wires (twisted pairs), found in many parking lots and building structures. Accordingly, use of such Echelon® networks facilitate and reduce cost. For example, US patent application 2003/0078677 discloses use of an Echelon® network to control, among other things, lighting in a parking lot. Unfortunately, Echelon® networks, when implemented using certain types of cables or wires, such as twisted pairs, to connect components thereof, do not provide sufficient levels of bandwidth to allow for transmission of video camera feed thereover to provide images of parking lot to a user of a computing device connected to the Echelon® network for surveillance of the parking lot. Thus, use of Echelon® networks, while practical for installation of network and cost effective, often means that another, separate network must be installed as part of system for capturing images of parking lot for security purposes.

In addition, while many parking lot control systems and methods allow for remote management and control of gate and provide for customer's use of access documents, such as radio frequency identifier (RFID) tags, to validate passage therethrough, these systems often require a user to visit an office and/or attendant at the parking lot to obtain the access document. Alternatively, the access document is ordered by the customer and then subsequently delivered, for example by mail, to the customer at a location specified thereby. In either case, obtaining the access document may require the customer to wait for delivery of the access document and/or may require customer to visit the parking lot between fixed hours when the office is open and/or an attendant is on duty, both of which can be inconvenient.

Accordingly, there is a need for an improved system and method for controlling passage through a gate of a parking lot that facilitates obtaining of access documents and capture of images for surveillance purposes, while still allowing use of inexpensive wiring and existing components typically found in many parking lots.

### SUMMARY OF THE INVENTION

It is therefore a general object of the present invention to provide an improved system and method of controlling movement of a gate of a parking lot for controlling passage of a customer therethrough in a vehicle.

An advantage of the present invention is that the system and method permit use of inexpensive wires, such as twisted pairs, typically already found in the parking lot to connect components used in the system and method.

Another advantage of the present invention is that the many of the components used in system are typically already found in parking lots and/or are inexpensive.

A further advantage of the present invention is that the system and method provide for capture and transmission of images of parking lot using such inexpensive/existent wires and equipment.

Still another advantage of the present invention is that the system and method provided allows customers to easily obtain access documents, with minimal delay, for use at parking lot to obtain passage through gate and use parking lot.

According to a first aspect of the present invention, there is provided a system for controlling passage through at least one electronic gate of a parking lot, the system comprising:
at least one access control module connected to the gate and being adapted for controlling movement thereof for controlling passage therethrough;
a lot control device for controlling the access control module; and
a first network connecting the access control module and the lot control device and by which the access control module and the lot control device communicate using Echelon® communication protocol.

In a second aspect of the present invention, there is provided a method for controlling passage through at least one electronic gate of a parking lot with an access control module connected to the gate and a lot control device connected to the access control module by a first network, the method comprising the steps of:
consulting an access rights record identified by an access identifier in a database connected to the lot control device, the access rights record comprising access rights defining a right of passage through the gate; and
after the consulting, controlling movement of the gate by the access control module based on the access rights to control passage through the gate.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a block system diagram of a system for managing and controlling access to the parking lot through a gate thereof, in accordance with an embodiment of the present invention;

FIG. 2 is a block diagram of components of an Echelon® network deployed in the system shown in FIG. 1;

FIG. 3 is a block diagram of components used for telephone communication in the system shown in FIG. 1;

FIG. 4 is a diagram showing an access document for use in system shown in FIG. 1 and the contents of a local and remote databases thereof;

FIG. 5 is a flow chart showing a procedure by which passage of a customer through gate of parking lot is controlled by the system shown in FIG. 1;

FIG. 6 is a flow chart of a procedure for capturing images of a parking lot with system shown in FIG. 1; and

FIG. 7 is a flow chart demonstrating establishment of telephone communication using system shown in FIG. 1.

### DETAILED DESCRIPTION OF THE PREFERRED EMBODIMENTS

With reference to the annexed drawings, the preferred embodiments of the present invention will be herein described for indicative purpose and by no means as of limitation.

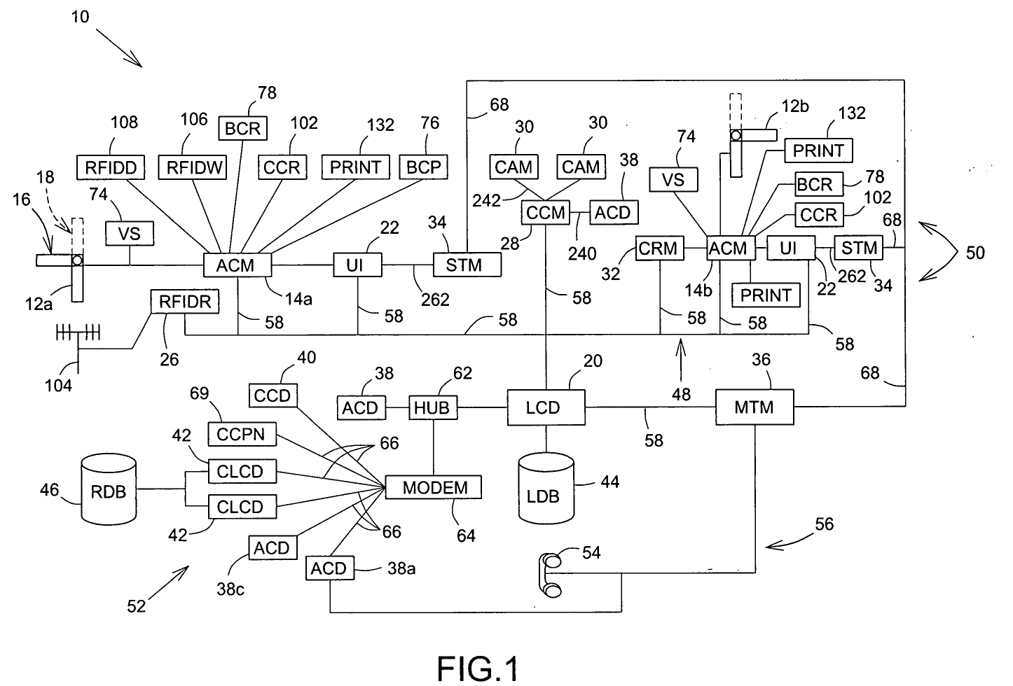

Reference is now made to FIG. 1, a block diagram of a system 10 for managing a parking lot and controlling access thereto through a gate 12 thereof. To aid the reader in understanding the invention, the description will initially focus on presenting system 10 and the components thereof. Next, use of system 10 by customer will be presented as a procedure, i.e. a method. Finally, methods by which system 10 provides for capturing images of parking lot and providing telephone communication are presented.

As shown in FIG. 1, gate 12 is connected to access control module (ACM) 14, which controls movement of gate 12 between a first position 16 and a second position 18 to control passage of a customer in a vehicle therethrough. In general, customer passes through gate 12 in a vehicle when gate 12 is in second position 18, i.e. when the gate is opened, the vehicle being prevented from passing through gate 12 when gate 12 is in first, i.e. closed, position 16. ACMs 14a, 14b are situated, respectively, at entry and exit of parking lot and/or of distinct zones thereof, in proximity to respectively, entry gate 12a and exit gate 12b. However, an ACM 14 may also be situated elsewhere in parking lot.

ACM 14 is connected to lot control device (LCD) 20, which provides control of ACM 14 within parking lot, and thereby movement of gate 12. In addition, LCD 20 also controls and manages most other components of system 10, including user interface (UI) 22 which provides for customer input and output and displays messages on display thereof, not shown, for customer, radio frequency (RF) identifier (RFID) reader (RFIDR) 26 for reading radio frequency identifiers, camera control means (CCM) 28 and cameras 30 connected thereto for capturing images of the parking lot and gates thereof, cash receiving means (CRM) 32 for receiving coins and banknotes from customer, and satellite telephony modules (STM) 34 and master telephony module (MTM) 36 which together provide for telephone communication between a customer and an attendant responsible for assisting customers. In general, CRM 32, STM 34, and UI 22 will be located in close proximity to ACM 14, possibly in the same housing as ACM 14. However, these components 22, 32, 34 may also be situated separately from ACM 14 in parking lot if desired.

LCD 20 is further connected to local data base (LDB) 44. LDB 44 contains, among other things, tariff information for access rights for passing through gate 12 and using parking lot, access identifiers which are associated with access rights records specifying access rights for a customer, records on entry and exit from parking lot for identifying movement of gate 12 between first and second positions 16, 18, and payments effected in parking lot for access rights. In general, there is one LCD 20 per parking lot, with the LCD 20 typically being situated therewithin. LDB 44 is also situated in parking lot and may, if desired, be co-located with LCD 20 in the same housing, i.e. as part of LCD 20.

LCD 20 is further connected to computing devices (CD) 38, 40, 42 from which, respectively, customers, attendants, and cluster administrators may effectuate operations relating to the use of parking lot and management thereof. CDs are generally of three categories. Attendant computing devices (ACD) 38 are generally used by attendants to monitor the parking lot, to provide assistance to customers, and to configure parking lot devices such as ACM 14 and LCD 20. Customer computing devices (CCD) 40 allow customers to remotely procure access rights and access documents corresponding thereto for using parking lot. Cluster administrator computing devices (CLCD) 42 are used by cluster administrators to monitor parking lot, assist customers as required, configure parking lot components such as ACM 14 and LCD 20, set costs for access rights, and verify transactions. In general, CLCDs 42 are connected to a remote database (RDB) 46, which remotely stores and archives all of the information found in LDB 44 and provides information thereto, the two databases 44, 46 updating each other in response to changes therein. RDB 46 may contain information on a plurality, i.e. a cluster, of parking lots, in which case the RDB 46 is connected to the respective LDB 44 of each parking lot in cluster via the respective LCD 20 for that parking lot. Thus, CLCD 42 connected to RDB 46 can be used to administrate and control any parking lot in the cluster. ACDs 38 also may access RDB 46 and may also be used to access and control multiple parking lots. However, the rights of attendants using ACDs 38 to administrate and control any parking lot via RDB 46, and LCD 20 connected thereto, are defined and controlled by a cluster administrator using CLCD 42. In general, an attendant can accomplish any task from an ACD 38 that can be accomplished by a customer from a CCD 40. A cluster administrator can accomplish any task from a CLCD 42 that may be executed by an attendant from an ACD 38. RDB 46 may be incorporated into a given CLCD 42 or may exist on a standalone computing device connected to CLCD 42.

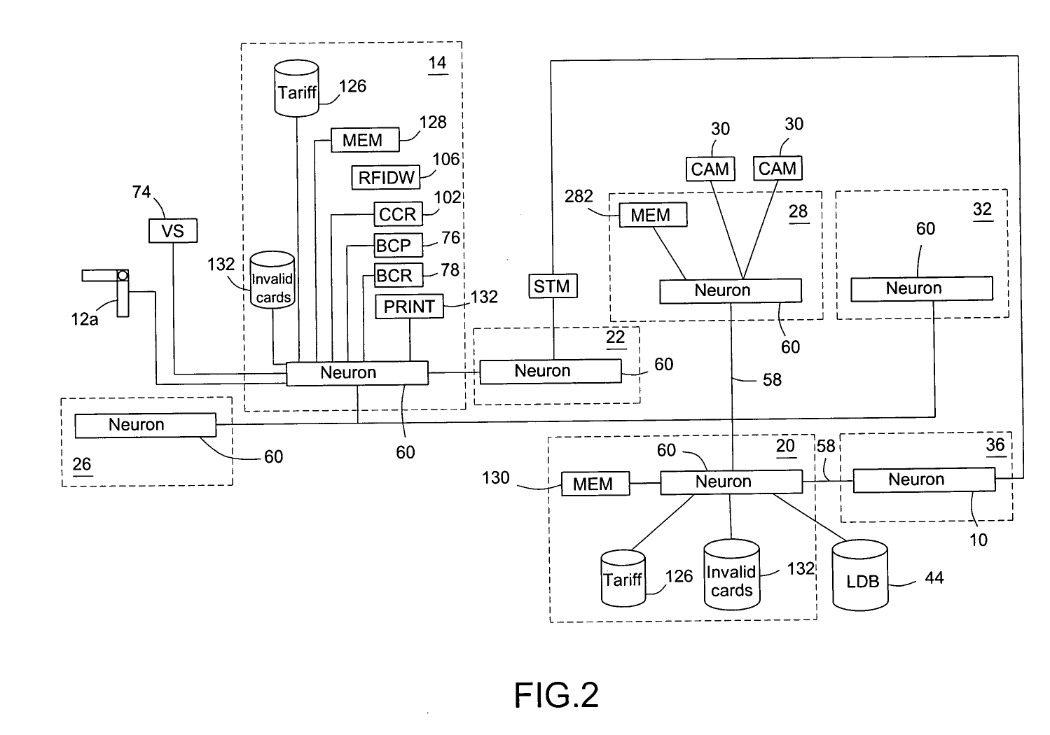

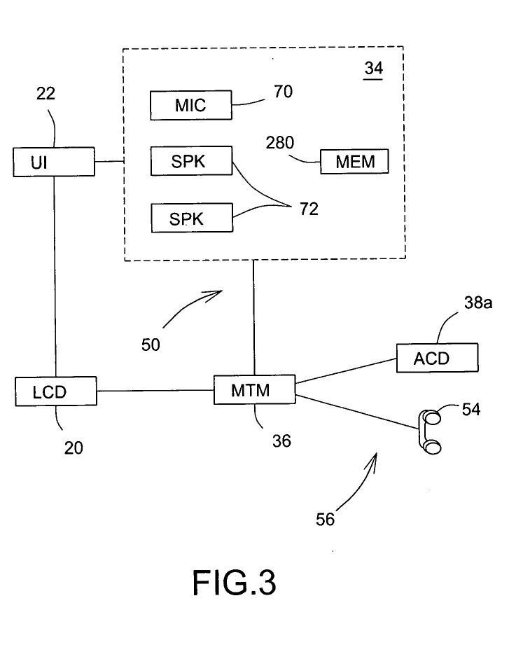

Reference is now made to FIGS. 1, 2, and 3. To provide the connections, whether direct or indirect, described above, system 10 has three networks. Firstly, an Echelon® network, shown generally as 48 in FIGS. 1 and 2, permits components of system 10 connected thereon to communicate with each other using the Echelon® protocol, provided by Echelon® corporation, to provide control of the compnents. Secondly, Internet network, shown generally as 52 in FIG. 1, provides communication with CDs 38, 40, 42, RDB 46 and LCD 20 via the Ethernet connections and/or the Internet. Thirdly, internal telephone network, shown generally as 50 in FIGS. 1 and 3, connects STM 34 and MTM 36 for telephone communication between STM 34 in parking lot, used by customer, and attendant telephone 54 used by attendant, by connecting STM 34 over internal telephone network 50 to MTM 36, which is connects to attendant telephone 54 over an external telephone network 56 extending outside of parking lot. It should be noted that LCD 20 is connected to three networks 48, 50, 52 and provides communication between networks 48, 50, 52 and components of system 10 connected directly or indirectly to networks 48, 50, 52.

Referring now to FIGS. 1 and 2, Echelon® network 48 connects components 14, 20, 22, 26, 28, 32, 36 by a series of Echelon® network links 58 for providing communication thereupon between components 14, 20, 22, 26, 28, 32, 36 using Echelon® protocol. In the embodiment, Echelon® network links 58 consist of twisted pairs of copper wires (twisted pairs), commonly found in many parking lots, telephone systems, and buildings. More specifically, all components 14, 20, 22, 26, 28, 32, 36 of system 10 directly connected to Echelon® network 48 are connected, in parallel, on the same twisted pair which serves as Echelon network link 58. In general, connection of components 14, 20, 22, 26, 28, 32, 36 on Echelon® network 48 in the embodiment is effected by deploying an Echelon® free topology transceiver (FFT-10) in each component 14, 20, 22, 26, 28, 32, 36. FTT-10 enables communication at 78 Kbps over a twisted pair of wires over a distance of up to 500 meters when Echelon® network 48 uses a free network topology. The distance of transmission can be increased to 2200 meters if a bus topology, including repeaters to repeat data transmitted, is deployed. Components 14, 20, 22, 26, 28, 32, 36 directly connected to Echelon® network 46 require a microprocessor 60 to process communications in Echelon® protocol. Thus, an Echelon® Neuron® microprocessor 60, connected to FFT-10, is present in each component 14, 20, 22, 26, 28, 32, 36 of system 10 directly connected to Echelon® network 48. However, any other microprocessor capable of processing commands and communicating in Echelon® protocol could be used. Further, if desired, the Echelon® network 48 could be implemented, instead of or in addition to twisted pair of wires, with other types of media, such as wireless radiofrequency transceivers, power lines, fibre optic cable, or the like, as Echelon® network links 58. In fact, Echelon network 48 may be implemented with any media, as Echelon® network links 58, that is capable of supporting communication thereon using Echelon® protocol. Similarly FTT-10 can be replaced by any other connector and/or interface compatible with Echelon® protocol and media deployed as Echelon® network links 57.

Echelon® network 48 advantageously allows use of existing and/or inexpensive wiring, such as twisted pairs, to connect components and to provide control thereof by communication of data and commands using Echelon® protocol, which is an open device control protocol. Thus, use of Echelon® network 48 and Echelon® protocol allows for programmable configuration and use of existing and/or inexpensive infrastructure for connecting and implementing control of components 14, 20, 22, 26, 28, 32, 36 of system 10, as well as other components of system 10 connected to components 14, 20, 22, 26, 28, 32, 36. Accordingly, reductions in cost for material, such as wiring, can be achieved by deploying Echelon® network 48. Further, reductions in time for installation and implementation of system 10 are also gained, as Echelon® network 48 provides easy connection between myriad devices and a protocol for communication therebetween. Complete information on Echelon® technology, including FTT-10, Neuron® processors 60, and Echelon® protocol is available from Echelon® corporation at Internet URL: http://www.echelon.com.

Referring again to FIG. 1, Internet network 52, which is connected via hub 62 and modem 64 to LCD 20, allows CD 38, 40, 42 connected to Internet network 52 to connect to RDB 46 over a series of Internet network links 66. Further, users, i.e. attendants and cluster administrators, of, respectively, computing devices 38, 42 connected to Internet network 52 are also capable of connecting thereby, with appropriate authorization to LCD 20 and LDB 44 to effect maintenance, control, and configuration thereof. Internet network 52 also connects LDB 44 and RDB 46, via LCD 20, hub 62, and modem 64, to allow communication therebetween for exchange and updating, i.e. synchronization, of information between RDB 46 and LDB 44. Internet network links 66 may be of any kind suitable for communication using Internet Transport Communication Protocol/Internet Protocol (TCP/IP), such as 10/100 base T cable, fiber optic cable, wireless links, Ethernet links, or the like. Thus, Internet network 52, or a portion thereof, may also be a wireless data network. Hub 62 may be of any kind, provided hub 62 is capable of connecting two or more CDs 38, 40, 42 and LCD 20 to Internet network 52. Modem 64 may be any type of modem suitable for transmission of data using TCP/IP. However, in the embodiment, modem 64 is preferably a high speed modem, such as an Asymmetric Digital Subscriber Line (ADSL) modem or cable modem. Further, ACD 38 and CCD 40 can be any type of computing device capable of receiving, transmitting, and processing information sent over internet network 52, including, for example, personal computers, laptop computers, and wireless computing devices, such as personal digital assistants (PDA's), and cellular phones. CLCD 42 may also be any type of computing device, including a wireless computing device. However, due to the management functions assigned thereto, CLCD 42 will preferably be a desktop or portable personal computer.

In general, Internet network 52 enables a number of operations, including control of LCD 20 and gate 12 from ACD 38 or CLCD 42, to assist customers. In addition, Internet network 52 allows entry, modification, and maintenance from CDs 38, 40, 42 of customer information, including access rights, in RDB 46 for subsequent updating of corresponding information in LDB 44. Further, Internet network 52 is also connected to a credit card processing network (CCPN) 69 to permit payment from computing devices 36, 38, 40, as payment receiving means, by credit card for access rights to parking lot by transmitting therefrom a customer's credit card number and respective expiry date to CCPN 69. In general, access to LDB 44, RDB 46, and LCD 20 is limited to users, i.e. customer, attendant, or cluster administrator, who have the requisite authorization credentials, typically a username and password assigned to user that must be entered from a computing device 38, 40, 42. In general, only attendants and cluster administrators will have authorization credentials permitting access to LCD 20 and LDB 44. Optionally, and for additional security, users may be restricted to use of authorization credentials from a specific CD 38, 40, 42. Communications between LDB 44, RDB 46, LCD 20, and CDs 38, 40, 42 are effected using 128 bit encryption for additional security, as are communications between CDs 38, 40, 42, LCD 20 and CCPN 69 over Internet network 52.

Referring now to FIGS. 1 and 3, internal telephone network 50, situated generally within the parking lot, connects one or more STMs 34 to MTM 36, via internal telephone network links 68. Internal telephone network links 68 are also conventional twisted pairs, but may be any other media suitable for carrying bi-directional telephonic communications. Internal telephone network 50 is an RS-485 network using the RS-485 bus interface, on twisted pairs, and communication can be effected thereon over a distance of 1 kilometer at 115 Kbps. Communication over network 50 can be extended for an additional kilometer if a repeater is installed. In general, telephone communication on internal telephone network 50 is digital, using a proprietary protocol. STM 34 has a microphone 70 for receiving voice of a customer using STM 34 and two speakers 72 for playing sound received from an attendant, who uses attendant telephone 54. Attendant telephone 54, in turn, is connected to MTM 36 by external telephone network 56, such as a traditional public telephone network, extending outside of parking lot. Thus, MTM 36 connects customer at STM 34 and attendant at attendant telephone 54 by creating a telephone communication connection therebetween over internal telephone network 50 and external telephone network 56, MTM serving as the bridge or gateway between networks 50, 56. MTM 36 may be connected to external telephone network 56 by a variety of links, including, for example, standard telephone lines and co-axial cable for cable telephony. External telephone network 56 may also be an Internet Protocol telephone network providing telephone communication using Voice Over Internet Protocol (VOIP) technology. Further, external telephone network MTM 36 may be a wireless telephone network or may contain wireless telephone links for wireless telephone communication to a cellular telephone and/or PDA as attendant telephone 54. A cellular telephone and/or PDA having telephone capability may, in addition to being attendant telephone 54, also serve as ACD 38a and therefore may be simultaneously connected to both Internet network 52, as ACD 38a, and to external telephone network 56 as shown in FIGS. 1 and 3.

To aid the reader in understanding the functioning of ACM 14, reference is made to FIGS. 1, 2, and 4. ACM 14 is responsible for controlling movement of gate 12, typically in response to messages received from LCD 20, between first and second positions 16, 18 for controlling passage of customer through gate 12 in a vehicle. Typically, ACM 14a, 14b is connected to least one vehicle sensor (VS) 74 situated in proximity to gate 12 for detecting proximity of a vehicle to gate 12. VS 74 may consist of, among other things, a photo sensor, a heat sensor, an optical sensor, an infra red sensor, and/or a height sensor designed to detect proximity of vehicle. ACM 14a is also connected to optional bar code printer (BCP) 76 for printing bar codes on bar code documents, such as cards or tickets, distributed to customers. Accordingly, when optional bar code printer 76 is deployed, ACM 14b may be connected to optional bar code reader (BCR) 78 for reading bar codes on bar code documents generated by BCP 76. As explained below, bar code documents serve as access documents 80 for system 10, with bar code encoding access identifier (access ID) 82 for access document 80. ACM 14, as well as any components connected directly thereto, will typically be activated whenever vehicle sensor 74 detects a vehicle in a pre-defined proximity to vehicle sensor 74.

ACM 14 may also be connected to receipt printer 132 for printing out receipts, optional RFID writer (RFIDW) 106 for writing RFID to RFID transponders 112 on RFID tags, and RFID tag distributor (RFIDD) 108,.which distributes RFID tags with RFIDs written thereupon by RFIDW 106 to customers. As explained below, RFID tags with RFID transponders, which broadcast RFIDs as access identifiers 82, serve as access documents 80. Finally, ACM 14 is also connected to credit card reader (CCR) 102 for reading credit card information, such as credit card numbers and expiry dates, from credit cards inserted therein by customers. Finally, ACM 14, which also has Neuron® microprocessor 60, is connected via Echelon network 48® to LCD 20, RFIDR 26, CRM 32, CCM 28, UI 22, and MTM 36, each of which also has a Neuron® microprocessor® 60, and can communicate with them via Echelon® protocol for processing and generating messages and commands. ACM 14 is also connected to Internet network 52 via LCD 20, hub 62, and router 64.

Reference is again made to FIGS. 1, 2 and 4. When customer arrives at ACM 14 and wishes to pass through gate 12 in vehicle, customer must present access document 80, having an access identifier 82 inscribed, i.e. encoded, thereupon, to an access document reading means capable of reading access identifier 82 on access document 80. Access identifier 82 is associated with an access rights record 84, typically stored in LDB 44 and, eventually, RDB 46. Access rights records 84 define access rights 86 for parking lot. Access rights 86 typically define a period of time, in which customer is authorized to use the parking lot and/or a specific zone thereof for parking of customer's vehicle therein. The period of time designated by access rights 86 is typically measured in time increments, for example increments of 15 minutes. Access rights 86 are verified by ACM 14 and/or LCD 20 whenever customer presents access document 80 to access document reading means, typically at exit and entry to parking lot, although access document reading means may also be present elsewhere in parking lot. Access rights record 84 typically also contains an amount due 100, referring to an amount that is immediately due for payment of access rights 86 and which must be paid immediately by customer using payment receiving means situated in parking lot before ACM 14, either alone or upon instruction from LCD 20, will cause movement of gate 12, typically from first position 16 into second position 18, to allow customer to pass therethrough. Should a customer not have access rights 86 for a parking lot or should a customer's access rights 86 be insufficient to cover the period of time customer has parked vehicle in parking lot when customer presents access document 80 to access document reading means, system 10 will oblige customer to procure additional access rights 86 which will be inscribed in access rights record 84, and will also calculate whether there is any amount due 100 for the additional access rights 86, which must be paid before ACM 14, either alone or upon instruction from LCD 20, will cause movement of gate 12 to allow passage of customer therethrough. Accordingly, access rights 86 define a customer's right to pass through gate 12.

It should be noted that acquisition of access rights 86 by customer does not automatically imply that an amount due 100 will be incurred. For example, as will be explained below, customers may be subscribers to parking lot, in which case customer may be billed on a periodic basis for access rights 86 procured and associated with access identifier 82 in access rights record 84. It should also be noted, as will also be explained in detail below, that CDs 38, 40, 42 can also be used in conjunction with a credit card of a customer as payment receiving means and for procuring access identifiers 82 and access rights 86 associated therewith, as well as for procuring access documents 80 associated with access identifier 82.

Reference is again made FIGS. 1, 2, and 4. Access document 80 may be a credit card of customer, in which case access identifier consists of a credit card number of the credit card, possibly with the expiry date of credit card, in which case access document reading means consists of CCR 102 which can electronically read credit card information inscribed on credit card, including credit card number of credit card, expiry date associated with credit card number, and, optionally, customers name. This credit card information is then transmitted from CCR 102 to ACM 14. CCR 102 may, for example, be a motorized magnetic card reader capable of reading one or more, and preferably at least three, magnetic strips and equipped with an RS-232 port for RS-232 communication with ACM 14, as well as a card detector for detecting presence of credit card in CCR 102. The credit card number, used as access identifier when credit card reader 102 is access document reading means, as well as the expiry date and possibly the customer's name are inscribed in one or more of the magnetic strips.

Access document 80 may also be a bar code document, i.e. a ticket or card having a bar code inscribed thereupon, the access identifier 82 typically being an alphanumeric string encoded as bar code. When access document 80 is bar code document, access document reading means is BCR 78, connected to ACM 14. BCR 78 can read bar code when bar code document is presented by customer thereto and translate bar code into the alphanumeric string representing access identifier 82. After reading bar code, BCR 78 transmits access identifier 82 encoded in bar code to ACM 14 connected to BCR 78. As noted previously, ACM 14a may also have BCP 76 connected thereto for printing access identifier 82 as bar code on bar code document, which can then be used as access document 80. Thus, customer can procure access document 80, i.e. bar code document, at parking lot. For example, BCP 76 may be activated by customer using ACM 14a or UI 22 situated at entry of parking lot which causes a message to be sent to ACM 14, the Neuron® processor 60 of which then instructs bar code printer 76 to print bar code on bar code document, as access document 80, which is then taken by customer. ACM 14a at entry to parking lot then causes gate 12a to move from first position 16 into second position 18, to allow user to pass therethrough to enter the parking lot. However, customer will have to present bar code document to BCR 78 connected to ACM 14b situated at exit of park for reading of bar code and pay any amount due 100 for access rights 86 associated with bar code as access identifier 82 in access rights record 84 before ACM 14b will move gate 12b from first position 16 into second position 18 to allow user to pass therethrough and exit parking lot.

BCP 76 may be, for example, a printer capable of printing a bar code on a paper, cardboard, or plastic ticket using the CODE 128C standard. The bar code, as access identifier 82, may contain, for example, twenty-four characters indicating, for example, the year, date, time, hour, minute, and second of entry into the parking lot, as well as an additional 6 characters. In such case, time of entry would therefore be stored directly on access document 80 and could be used, notably when LDB 44 and LCD 20 are unavailable, by ACM 14b in conjunction with BCR 78 to calculate amount due 100. Alternatively, BCP 76 could encode different data, such as a credit card number, as bar code for use as access identifier 82. BCR 78 must be able to read bar codes using the bar code standard chosen. Thus, for the purposes of this example, BCR 78 would have to be able read a twenty-four character bar code encoded using the CODE 128C standard. BCP 76 and BCR 78 may also have RS-232 ports for RS-232 communications with, respectively, ACM 14a, 14b.

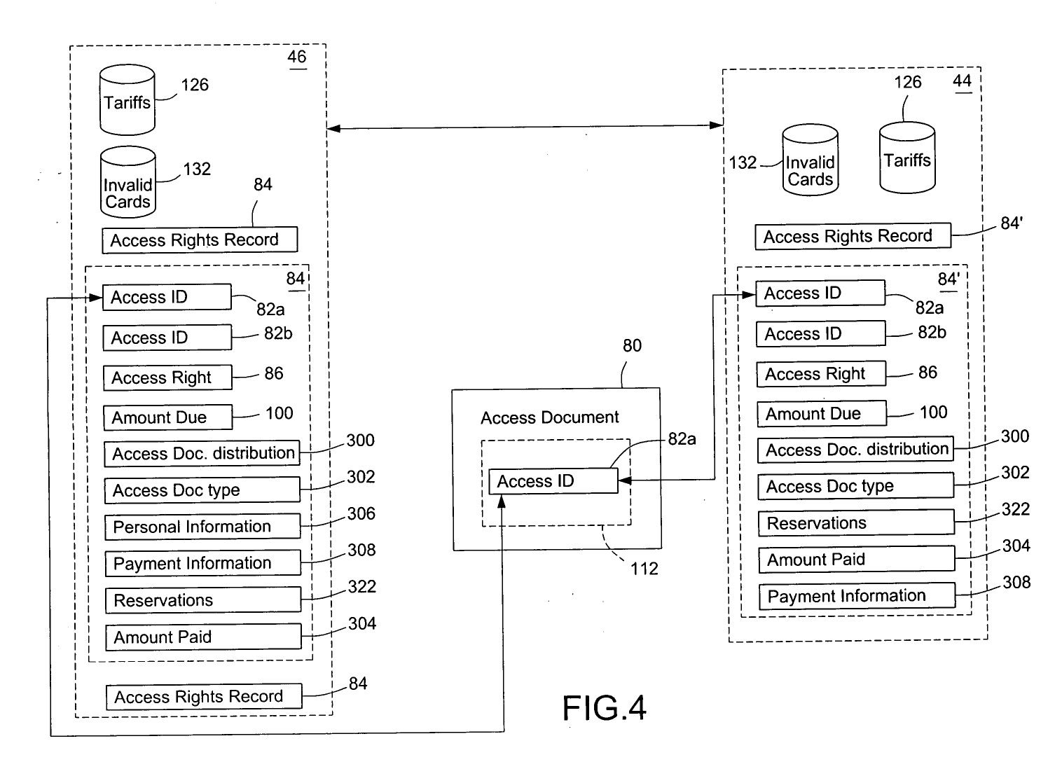

Referring still to FIGS. 1, 2, and 4, access document 80 may also be an RFID tag having a transponder 112 for broadcasting an RFID, in which case access identifier 82 is encoded as RFID. The RFID, as access identifier 82, is received by at least one antenna 104 connected to RFIDR 26, which together serve as access document reading means. More specifically, RFIDR 26 decodes RFID received by antenna 104 into an alphanumeric string representing access identifier 82 and transmits the access identifier 82 in Echelon® protocol over Echelon® network 48 to ACM 14 and, optionally, LCD 20. ACM 14 may, optionally, have RFID tag distributor (RFIDD) 108 with RFIDW 106 optionally connected thereto. RFIDW 106 writes access identifier 82 as RFID to transponder 112 of RFID tag, which is then distributed by RFIDD 108 to customer, thus allowing customer to obtain RFID tag as access document 80 directly in parking lot. As an example, RFID tag may be a low frequency RFID tag in which transponder 112 broadcasts RFID, modifiable by a radio signal, at low frequency for reception and reading by RFIDR 26 up to 1.5 meters away. The RFID, i.e. access identifier 82, could be encoded as 64 bits including a checksum. RFIDW 106 could be a radio transmitter for wirelessly transmitting a radio message for wirelessly writing and modifying RFID. RFIDD 108 may be a container having one or more compartments, each compartment having an electronically controlled door which opens on command by ACM 14, i.e. neuron processor 60 thereof. In such case, each compartment could house, at any given moment, one RFID tag having RFID for customer written thereto by RFIDW 106. Upon arrival at ACM 14, customer could, possibly by using another access document 80 such as a credit card, request distribution of RFID tag, possibly ordered in advance by customer from CD 38, 40, 42. In response to customer's request, RFIDW 106 would write RFID encoding access identifier 82 onto transponder 112 of RFID tag, if the access identifier 82 for customer is not already written thereto. Provided RFID, i.e. access identifier 82, has been written to transponder 112, ACM 14 then opens door to compartment housing RFID tag, thus effecting distribution of RFID tag as access document 80. As shown in FIG. 4, RFIDD 108 and RFIDR 106 may be housed and/or co-located with ACM 14. However, as shown in FIG. 1, it is also possible that RFIDD 108 and RFIDR 106 be housed outside of ACM 14.

It should be noted that, regardless of type of access document, access identifier 82 inscribed thereupon may be credit card number of credit card of customer. Further, customer may have multiple access identifiers 82 which are associated with each other for designating the same access rights record 84. For example, a customer could have an RFID as a first access identifier 82a and a credit card number as a second access identifier 82b associated with the same access rights record 84. The customer could then use either credit card, having credit card number inscribed thereon as access identifier 82b, or RFID tag, having RFID inscribed as access identifier 82a, as access document 80 for the same access rights record 84.

In general, when RFIDW 106, RFIDD 108, and/or BCP 76 are present, alpha numeric string of alpha numeric characters for access identifier 82 and access rights record 84 may be generated by a number of methods. Firstly, Neuron® processor 60 of ACM 14 may generate access identifier 82, as an alphanumeric string, and transmit it to RFIDW 106 or bar code printer 76 for writing as, respectively, bar code or RFID. Neuron processor 60 of ACM 14 may also, based on customer selections entered by customer into UI 22 and parking tariffs calculated by ACM 14 and/or LCD 20, generate or modify access rights record 84 including access rights 86 and amount due 100, for access identifier 82, which is then transferred to LCD 20 over Echelon® network 48 for storage in LDB 44. Alternatively, alphanumeric string for access identifier 82 can be generated by Neuron® micrprocessor of LCD 20 and transmitted in Echelon® protocol over Echelon® network 48 to Neuron® microprocessor 60 of ACM 14, which then transmits access identifier 82 to RFIDW 106 or BCP 76 for writing as, respectively, RFID or bar code. In this case, Neuron® microprocessor 60 of LCD 20, based on customer selections at UI 22 and tariffs calculated by LCD 20 and/or ACM 14, generates and/or modifies access rights record 84, including access rights 86 and amount due 100 and transmits access rights record 84 to LDB 44. Typically, RDB 46 is subsequently updated with all information stored in LDB 44.

Alphanumeric string for access identifier 82, as well as access rights record 84 including access rights 86 and amount due 100, may also be generated and modified by requesting RDB 46, from CD 38, 40, 42, to generate and/or update access identifier 82 and access rights record 84. In such case, RDB 46, based on information entered into CD 38, 40, 42 for access rights 84 and type of access document 80, i.e. credit card, RFID tag, or bar code document, generates and/or modifies access rights record 84, including access identifier 82, and transmits the access rights record 84 over internet network 52 to LCD 20 which in turn transmits the record 84 to LDB 44. Once access rights record 84 is present on LDB 44, access identifier 82 thereof may be transferred by LCD 20 to ACM 14, which may then transmit access identifier 82 to RFIDW 106 or BCP 76 for writing as, respectively, bar code on bar code document or RFID on RFID transponder 112 of RFID tag. Thus, customers can procure access rights 86 and access identifier 82 outside of parking lot and/or in advance of customer's arrival at parking lot, and thereby obtain a subscription to parking lot, i.e. become a subscriber to parking lot, and/or reserve a parking space in parking lot prior to arrival therein. Access document 80, i.e. bar code document or RFID tag, may then be distributed to customer at parking lot using BCP 76 or RFIDW 106, in conjunction with RFIDD 108, or may be distributed to customer outside of parking lot, for example, by mailing RFID tag or bar code document to customer.

Further, and advantageously, when requesting creation and/or update of access rights record 84 from, respectively, CD 38, 40, 42, attendants, customers, and cluster administrators may enter a credit card number and, optionally, a respective expiry date of a credit card of customer as access identifier 82 for access rights record 84. Since CCR 102 may be used as access document reading means, customer may thus instantly obtain an access document 80, i.e. credit card already in customer's possession. As many credit card readers 102 can generally read debit cards issued by financial institutions, a debit card number for a debit card held by customer could similarly be entered into CD 38, 40, 42 as access identifier 82 to allow customer to instantly use debit card as access document. As with credit card when used as access document 80, customer would then, upon arrival at parking lot, insert debit card into CCR 102, as access document reading means, which would transmit debit card number, as access identifier 82, to LCD 20 to identify access rights record 84 associated therewith in LDB 44. Based on access rights 86 and amount due 100, customer could then pass through gate 12.

In addition, since customer may have more than one access document 80 and more than one access identifier 82 associated with access rights record 84, CD 38, 40, 42 can be used to request that credit card number be assigned as access identifier 82 for use with credit card as access document 80 on a temporary basis, if desired, i.e. as a temporary access identifier 82b and temporary access document 84. At the same time, CD 38, 40, 42 can be used to request that an additional access document 80, such as a bar code document and/or RFID tag be assigned to customer, perhaps as permanent access document 80 having a permanent access identifier 82, and this additional access document 80 be subsequently distributed to customer. For example, customer could have access rights record 84 created or modified on CD 38, 40, 42 using credit card number as access identifier 82b and credit card as a first, perhaps temporary, access document 80 and also request a bar code document or RFID tag, as a second, perhaps permanent, access document 80 to be picked up by customer from ACM 14 at parking lot. Access rights record 84, as requested from CD 38, 40, 42, would then be created or modified on RDB 46 and transferred to LDB 44. Customer could then, upon arrival at parking lot, insert credit card as access document 80 into CCR 102. CCR 102 would then read credit card number, and possibly expiry date, and this credit card information would be transferred by Neuron® microprocessor 60 of ACM 14 to LCD 20 over Echelon® network 48. LCD 20, and notably Echelon® microprocessor 60 thereof, would then look up credit card number in LDB 44, which would be identified therein as first, possibly temporary, access identifier 82b for access rights record 84. LCD 20, notably Neuron® processor 60 thereof, would then consult access rights record 84, which would include second, possibly permanent, access identifier 82a and access document distribution information 300 specifying that bar code document or RFID tag is to be distributed as second, possibly permanent, access document 80 to customer. LCD 20 would then transmit access rights 86, as well as any amount due 100, second access identifier 82a, whether the same or different than credit card number, along with message to distribute second access document 80, i.e. bar code document or RFID document, to ACM 14. In response, ACM 14 would prompt user to pay any amount due 100 via UI 22. Once amount due 100 is paid, or if there is no amount due 100, ACM 14 would then send a message containing second access identifier 82a to BCP 76 or RFID writer 102, depending, respectively, on whether second access document 80 designated in access document distribution information 300 is specified as bar code document or RFID tag. If second access document 80 is RFID tag, RFIDW 106 writes RFID encoding second access identifier 82a to transponder 112 of RFID tag and RFID tag is distributed to customer by RFIDD 108. If second access document 80 is bar code document, BCP 76 prints bar code on bar code document, which is then retrieved from BCP 76 by customer. Customer may then use bar code document or RFID tag as access document 80.

It should be noted that tariff information 126 for parking lot is stored in LDB 44, RDB 46, ACM 14, and LCD 20, thus ensuring that LCD 20 and ACM 14 are always capable of calculating amount due 100. Further, ACM 14 and LCD 20 each have, respectively, ACM memory unit 128 and LCD memory unit 130 for temporarily storing access rights record 84 in the event that LDB 44 and RDB 46 are unavailable, thus allowing ACM 14 and LCD 20 to temporarily act as standalone devices, the access rights records 84 being temporarily stored thereon and transferred to LDB 44, and eventually RDB 46, when LDB 44 and RDB 46 become available. It should further be noted that attendants and cluster administrators may be able to directly modify and create access rights records 84 on LDB 44 from, respectively, ACD 38 and CLCD 42. However, in all cases of creation or modification of any data on either LDB 44 or RDB 46, the data modified or created thereupon relative to any parking lot associated with a given LDB 44 will eventually be synchronized on LDB 44 and RDB 46.

It is also important to note that many other technologies may be used as access documents 80 having access identifiers 82 for reading by access document reading means. For example, access document 80 could be a so-called “smart card” having an electronic chip with access identifier 82 inscribed thereon for reading by a “smart” card reader. Access document 80 could also be a document or mechanism encoding access identifier 82 in a format readable by an optical reader or infra-red signal detector/reader, in which case, respectively, the optical reader or infra-red signal detector/reader would serve as access document reading means. Access document 80 could also be, similar to the case of credit card/debit card, a magnetic card having a magnetic strip in which access identifier 82 is encoded for reading by a magnetic card reader. In brief, any media capable of encoding an access identifier 82 that is readable by a machine or device, as access document reading means, for transmission to LCD 20 may be deployed as access document 80.

Referring still to FIGS. 1, 2, and 4, to ensure payment of amount due 100 for access rights 84, system 10 also has at least one payment receiving means, namely computing devices 38, 40, 42, CCR 10, and/or CRM 32. Specifically, CRM 32 is connected directly to Echelon® network 48 and has it own Neuron® microprocessor 60 for communicating with LCD 20, UI 22, and ACM 14 using Echelon® protocol. CRM 32 is also connected to Internet network 52 through LCD 20, hub 62 and modem 64. CCR 102 is connected to Echelon® network 48 via neuron processor 60 of ACM 14 and to Internet network 52 through LCD 20, modem 64, and hub 62. Receipt printer 132, connected to Neuron® processor 60 of ACM 14, prints receipts of payments effected by CCR 102 and CRM 32. While payment receiving means may be available at ACMs 14a situated in proximity to entry to of parking lot, they are always available in proximity to ACMs 14b situated in proximity to exit of parking lot to ensure that any amount due 100 for access rights 86 is paid prior to moving gate 12b to allow customer to pass therethrough and exit parking lot. Further, it should be noted that time of entry into parking lot is always recorded in association with, and possibly as, an access identifier 82, on ACM 14 and, by LCD 20, in LDB 44, regardless of access document 80 used for entry. Thus, amount due 100 can always be calculated, based on exit time using tariff information 126 stored in LDB 44, ACM 14, and LCD 20.

Generally, to effect payment within parking lot, customer presents access document 80 to access document reading means, i.e. CCR 102, RFIDR 26, or BCR 78. Access identifier 82 is then transmitted to LCD 20 which calculates amount due 100 based on time and date of entry and/or exit and by consulting access rights record 84 in LDB 44, if LDB 44 is available, which may indicate that an amount due 100 is payable based on a variety of factors, such as: whether access rights 86 have been pre-paid in advance, whether user is billed by mail for surplus use at home or work, etc. For example, access rights record 84 may indicate that customer is a subscriber that is billed on a periodic basis for access rights 86 at a home address or to a credit card number of customer. In such case, access rights record 84 in LDB 44 would indicate that there is no amount due 100 for access rights 86 used for parking in parking lot. However, in this example, any use of parking lot not covered by the access rights 86 that are indicated in access rights profile 86 as already being paid would nevertheless be recorded for eventual billing to customer. Alternatively, as another example, access rights record 84 could indicate that customer is a subscriber that has pre-paid for a subscription conferring unlimited access for a given time period in which customer used parking lot, in which case there would also be no amount due 100 and no further billing would be undertaken. Access rights record 84 could also indicate, for example, that customer has no subscription, i.e. is not a subscriber, that the subscription does not confer access rights 86 for the period in which parking lot is used, or that a payment for a subscription conferring access rights 86 for use of parking lot is immediately due, in which case an amount due 100 will be payable using payment receiving means and calculated by LCD 20 in conjunction with LDB 44. Should LDB 44 be unavailable, LCD 20 will calculate and require payment of an amount of money as amount due 100 based on tariff information 126, stored on ACM 14, LCD 20, and LDB 44, time of entry and, if applicable, time of exit, time of entry being temporarily stored in association with access identifier 82 either on access document 80, LCD 20, or ACM 14 and time of exit, if applicable, being stored temporarily on ACM 14 and/or LCD 20. Once LDB 44 is available again, time of entry, time of exit, and amount paid 304 as amount due 100 are transferred thereto and credited to access rights record 84. Similarly, should LCD 20 be unavailable, ACM 14 will calculate an amount of money to be paid as amount due 100 based on tariff information 126 stored on ACM 14, time of entry and, if applicable, time of exit, time of entry being temporarily stored in association with access identifier 82 either on access document 80 or ACM 14 and time of exit, if applicable, being stored temporarily on ACM 14. Once LCD 20 is available again, time of entry, time of exit, and amount paid 304 as amount due 100 are transmitted thereto for storage thereby in access rights record in LDB 44 when LDB 44 is available. In this fashion, system 10 always ensures that access rights 84 are paid for, even if LCD 20 and LDB 44 are unavailable.

If there is an amount due 100, i.e. an amount due 100 calculated by ACM 14 and/or LCD 20 is greater than zero, LCD 20 or, if LCD 20 is unavailable, ACM 14 will transmit amount due 100 to UI 22 which displays amount due 100 and requests payment thereof. Customer may then use payment receiving means, namely CRM 32 or CCR 102, to pay amount due 100. Once payment of amount due 100 is successfully effected, payment thereof is recorded by LCD 20 in LDB 44 as amount paid 304 in access rights record 84 associated with access identifier 82 and LCD 20 sends message to ACM 14 over Echelon® network 48 authorizing passage of customer in vehicle through gate 12. Again, if LDB 44, but not LCD 20, is unavailable when payment is effected, amount paid 304 for payment of amount due 100 will be temporarily stored on LCD 20 and forwarded to LDB 44 for storage in access rights record 84 as soon as LDB 44 again becomes available. If LCD 20, and therefore LDB 44 as well, is unavailable for ACM 14 when payment of amount due 100 is effected, ACM 14 causes gate 12 to move from first position 16 to second position 18 to allow passage therethrough and will temporarily store amount paid 304 for payment of amount due 100 in association with access identifier 82, which will be forwarded to LCD 20 for storage in LDB 44 as soon as connection to LDB 44 via LCD 20 becomes available. After passage of customer in vehicle through gate 12, ACM 14 returns gate 12 to first position 16 to prevent unauthorized passage therethrough. Payment of amount due 100 and amount paid 304 are forwarded to RDB 46 from LDB 44, via LCD 20 and Internet network 52 for storage therein in association with access identifier 82 to update RDB 46.

If user selects CRM 32 for payment of amount due 100, customer inserts coins and banknotes into CRM 32 which records the amount paid 304 therein and transmits the amount paid 304 to LCD 20 or, if LCD 20 is unavailable, to ACM 14. Once the amount paid 304 at CRM 32 is equal to the amount due 100, ACM 14 causes gate 12 to move from first position 16 into second position 18 to allow customer to pass therethrough. Payment of amount due 100 is transferred to LDB 44, as described above, via LCD 20 for storage in association with access identifier 82 in access rights record 84. Access rights record 46 on RDB 46 is then updated with payment of amount due 100 from LDB 44.

Should customer elect to pay amount due 100 using CCR 102, user inserts credit card into CCR 102, which serves as payment receiving means. CCR 102 reads credit card number and respective expiry date of credit card, which are transmitted thereby, through Neuron® microprocessor 60 of ACM 14, to LCD 20 in Echelon® protocol over Echelon® network 48. LCD 20, i.e. Neuron® microprocessor 60 thereof, receives credit card number and expiry date and, if LDB 44 is available, consults LDB 44 to determine whether credit card is inscribed on an invalid card list 132 of invalid credit card numbers. If so, LCD 20 instructs ACM 14 to refuse credit card, which is either returned to customer or retained by CCR 102 for fraud prevention purposes. If credit card is not on invalid card list 132, LCD 20 further consults LDB 44 to determine whether there is an access rights record 84 associated with credit card number, i.e. whether credit card number is an access identifier 82 for customer, in which case credit card is, in itself, an access document 80. If credit card is an access document 80, LCD 20 will check, again for fraud prevention purposes, whether expiry date for credit card was entered as part of access rights record 84 and, if so, whether expiry date read by CCR 102 matches that in access rights record 84. If these expiry dates are not the same LCD 20 instructs ACM 20 to refuse credit card, which is either returned to customer or retained by CCR 102 for fraud prevention purposes. If expiry dates are the same, then LCD 20 transmits amount due 100 with credit card number and respective expiry date through hub 62 and modem 64 to CCPN 69 connected to Internet network 52. CCPN 69, typically maintained by financial institutions for credit cards such as Mastercard®, Visa®, American Express® or the like, receives the amount due 100, credit card number, and expiry date, and processes payment of amount due 100 by either authorizing or declining the payment of the amount due 100 and sending respectively either a payment authorized message or payment declined message back to LDC 20. If payment of the amount due 100 is declined by CCPN 69, LCD 20 instructs ACM 14 to refuse credit card, which is either returned to customer or retained by CCR 102 for fraud prevention purposes. If the payment is authorized by CCPN 69, then LCD 20 records, in LDB 44, amount paid 304 and records the amount due 100 as paid in LDB 44, along with an authorization number transmitted as part of authorization message. LCD 20 then instructs ACM 14 to allow passage through gate 12. If credit card is not an access document 80 or the expiry date was not previously recorded in association with credit card number in LDB 44, LCD 20 conducts the same steps as for when credit card is an access document 80, except that credit card and expiry date are not verified in LDB 44. It should be noted that credit card numbers and respective expiry dates, can be recorded in RDB 46 and LDB 44 in association with access identifier 82 as part of access right record 84 to allow LCD 44 to obtain payment of amount due automatically by transmitting the credit card number and expiry date along with amount due 100 to CCPN 69, without requiring customer to insert credit card into CCR 102, thus saving customer time and effort.

It should be noted that, if CCPN 69 is also able to process debit card transactions, customer could also use CCR 102 to pay amount due 100 with a debit card. In such case, user would insert debit card into CCR 102 and then enter the customers Personal Identification Number (PIN) using UI 22. Debit card number of debit card would be read by CCR 102 and transmitted, along with PIN entered into UI 22 and amount due 100, to CCPN 69 for processing, very much in the same manner as for credit cards, except that expiry date for debit card would not need to be verified. If CCPN 69 is not able to process debit card payments, system 10 could nevertheless be connected to a debit card payment network, not shown, by Internet network 52, in which case debit card network would function in the same manner as just described for CCPN 69 with regard to debit card payments to enable use of debit cards for paying amount due 100.

When customer is not present in parking lot, CDs 38, 40, 42 may be used as payment receiving means, in conjunction with credit card number and expiry date of credit cards held by customer, to pay amount due 100, arrange pre-payment of access rights for a subscription, and to purchase new access rights 84. In such case, credit card number, and possibly respective expiry date thereof, are entered from CD 38, 40, 42 along with access identifier 82, which identifies access rights record 84 in RDB 46. As mentioned previously, credit card number and expiry date may also be registered in association with access identifier 82 as part of access rights record 84 in RDB 46, and transferred therefrom to LDB 44, in which case only access identifier will need be entered from CD 38, 40, 42 and user of CD 38, 40, 42 will be able to select any credit card number associated therewith for payment of amount due 100. Credit card number, whether directly entered from CD 38, 40, 42 or provided by RDB 46 is then checked against invalid card list 132. If the credit card number is not on invalid card list 132, credit card number, expiry date, and amount of payment, for example amount due 100, are transmitted over Internet network 52 to CCPN 69. Payment is then authorized or declined by CCPN 69, as described above for use of CCR 102. If payment is declined by CCPN 69, then a message to this effect is displayed by CD 38, 40, 42 and, if user of CD 40, 42 is an attendant or cluster administrator to which customer has physically presented credit card for payment, attendant or cluster administrator may retain credit card for fraud prevention purposes. If payment is authorized by CCPN 69, payment is then recorded in RDB 46 and, if required, LDB 44 is subsequently updated to reflect payment. Notably, if amount due 100 is paid, access rights record 84′ in LDB 44 will be updated to reflect that amount due 100 is zero. For example, such payments may be effected by customers over the telephone or in person by communicating with attendants or administrators who could effectuate the payment by entering credit card number and expiry date, as well as amount due 100 from, respectively, an ACD 38 or CLCD 42. If payment is effected in person to attendant or administrator, payment may also be made in cash and/or any other form for which attendant and administrator are equipped to receive payment, in which case attendant and/or administrator receive payment of amount due 100 and enter payment thereof into RDB 46 and transferred therefrom to LDB 44.

Access rights record 84, including access rights 86, access identifier 82, access document distribution information 300, access document type information 302 specifying types of access documents associated with access identifiers 82 for access rights record 84, credit card number and expiry date, reservations 322 for parking lot, as well as any other information desired or required for access rights record 80, may be created and modified by customer, attendant, or cluster administrator respectively from CCD 40, ACD 38, and CLCD 42. Typically, creation or modification of access rights record 84 is effected from CD 38, 40, 42 by accessing RDB 46 over Internet network 52. The access rights record 84, or at least access identifier 82, amount due 100, and access rights 86, type of access document 80, access document distribution information 300, access document type information 302 and any reservations 322 associated with access identifier 82 for parking spaces in parking lot, are then transferred to LDB 44 for storage in access rights record 84′ thereof. Administrators and attendants can also issues commands from, respectively, ACD 38 and CLCD 42 to ACM 14, via LCD 20, to instruct ACM 14 to allow passage through gate 12, namely by causing gate 12 to move from first position 16 to second position 18, or to deny passage through gate 12 by moving gate 12 or maintaining gate 12 in first position 16.

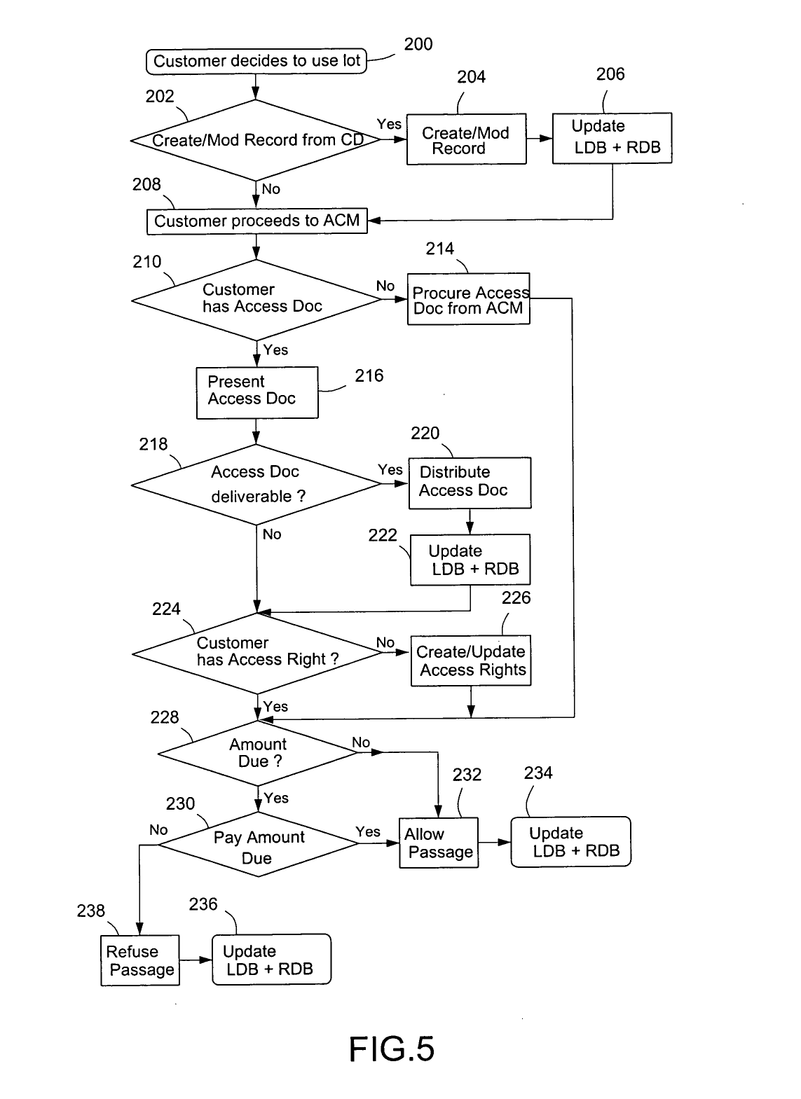

To provide the reader with a better understanding of use of system 10 from a customer's perspective, reference is now made to FIG. 5, which presents a flow chart outlining use and functioning of system, in conjunction with FIGS. 1 and 4. As shown in FIG. 5, typically customer's interaction with system commences at step 200, when customer decides to use a parking lot for which system 10 is implemented. Customer may then choose, as shown at step 202, whether customer wishes to create or modify access rights record 84 to obtain or modify an access identifier 82 and/or access rights 86 for the parking lot and/or to obtain an access document 80 therefore via a CD 38, 40, 42. This is usually the case when customer wishes to complete such transactions in advance of use of parking lot and/or when customer is not situated at ACM 14, e.g. when customer is situated outside of parking lot. If customer wishes to create or modify access rights record 84, access rights 86, and/or access document 80, such as credit card, from CD 38, 40, 42, then, proceeding to step 204, an access rights record 84 for customer is created or modified from CD 38, 40, 42, to confer access rights 86 to customer and to associate rights with access document 80, which may also be configured and ordered by, or for, customer from CD 38, 40, 42 at this step 204. This is typically the procedure when customer wishes to subscribe, i.e. become a subscriber, to a given parking lot. It is also the normal procedure when a customer wishes to use credit card as an access document 80, either on a permanent basis or as a temporary access document 80 prior to obtaining an RFID tag or bar code document for use as a permanent access document 80, i.e. for use on a permanent basis. Typically, step 204 is conducted by customer from CCD 40 or by an attendant or cluster administrator at the request of a customer from, respectively, an ACD 38 or CLCD 42. Customer may also choose to pay for access rights 86 and any amount due 100 at this step either by paying attendant or cluster administrator and/or using a credit card to provide credit card number and expiry date to CD 38, 40, 42, which also serve as payment receiving means, as previously described. Any creation of modification of access rights record 84 is then stored, at step 206, on RDB 46 and LDB 44 of parking lot, typically with RDB 46 being updated first and then transferring the new or modified access right record 84 to LDB 44 for storage thereon as access rights record 84′.

If customer decides not to create or modify access rights record 84 outside of parking lot or away from ACM 14, or once this operation is completed, customer arrives, at step 208 at parking lot, typically at ACM 14 thereof. If customer does not have access document 80, evaluated at step 210, then customer proceeds to step 212. Otherwise, customer proceeds to step 216. At step 214, customer procures an access document 80, typically a bar code document having access identifier 82 printed thereon by BCP 76 as a bar code. The bar code document is typically obtained at ACM 14a, i.e. at entry to parking lot. Simultaneously, still referring to step 214, an access rights record 84′ having the access identifier 82 and access rights 86 acquired therewith is created in LDB 44 and eventually transferred therefrom to RDB 46. Customer then proceeds to step 228. At step 216, customer presents an access document 80, temporary or permanent, which, as previously stated, may be either a credit card, bar code document, or an RFID tag, to access document reading means, which reads access identifier 82 from access document 80 and forwards it to LCD 20, which consults LDB 44. At step 218, by consulting access rights record 84′ in LDB 44, LCD 20 determines whether another access document 80, for example a permanent access document 80, is to be delivered to customer at this time, based on contents of access document distribution information 300. If not, then the next step is step 228. Otherwise, at step 220, access document 80 is distributed to customer at ACM 14, typically by printing from bar code printer 78 or by writing access identifier to transponder 112 by RFIDW 106 and subsequent distribution of RFID tag to customer from RFIDD 108. This is usually the case when customer, at step 204, elects to use credit card as access document 80 with credit card number as access identifier as an initial access document 80, either temporary or permanent, prior to obtaining an RFID tag or bar code document as access document 80. At step 222, following distribution of access document 80, access rights record 84′ in LDB 44 is updated to reflect that access document 80 has been delivered. Access rights record 84 for the same access identifier 80 in RDB 46 is, subsequently, also updated with this information. The process then proceeds to step 224.

At step 224, LCD 20 consults LDB 44 to determine whether, for access identifier 82 of access document 80 presented or distributed, access rights 86 have been inscribed in corresponding access rights record 84′ for parking lot where document 80 is presented. If yes, then step 228 is next. Otherwise, at step 226, access rights 86, generally at request of customer using UI 22, are created/accorded for parking lot, and step 228 is next.

At step 228, either ACM 14 or LCD 20 calculates, as described previously, whether there is an amount due 100 and the actual amount of amount due 100. If there is no amount due, i.e. amount due 100 is zero, then ACM 14 causes, at step 232, movement of gate 10 to allow passage through gate 12 and LDB 44 is updated, at step 234, to record passage, including time thereof, in association with access identifier 82, of customer through gate 10. RDB 46 is subsequently updated in the same fashion, based on information in LDB 44, to record therein passage of customer through gate 12. The process, now at step 234, ends. From step 228, if amount due is greater than zero, then, at step 230, customer is given the opportunity to pay amount due 100 using payment receiving means at parking lot, namely CCR 102 or CRM 32. If customer successfully pays amount due, then the next steps are, respectively, steps 232 and 234, as previously described. Otherwise, customer is refused passage, at step 238, through gate 12. Refusal of passage, including time of refusal, is recorded in LDB 44 in association with access identifier 82 in LDB 44 at step 236, at which point the process ends. The refusal of passage through gate 12 is also recorded in RDB 46, based on information provided thereto from LDB 44.

Referring again to FIGS. 1 and 2, to provide surveillance, system 10 deploys a variety of cameras 30 connected to CCM 28, which has Neuron® processor 60 for communicating with LCD 20 using Echelon® protocol over Echelon® network 48. Optionally, CCM 28 may also be directly connected by an RS-485 bus link 240 on a twisted pair of wires, to an ACD 38, e.g. a portable computing device. CCM 28 is connected to each camera 30 using a coaxial cable link 242 of coaxial cable and connected to Echelon® network 48 with Echelon® network link 58 consisting of a twisted pair of wires. It should be noted that other types of cables and wires may be used to connect camera 30 to CCM 28, provided that video and/or images can be transmitted thereover to CCM 28. Similarly, other types of cable and wires, other than twisted pairs, may be used as Echelon® network link 58 to connect CCM 28 to Echelon® network, provided that the cables and/or can transmit data using Echelon® protocol. Further, connection between CCM 28 and ACD 38 need not necessarily be an RS-485 link 240. Any cable or wire by which CCM 28 and ACD 38 may be connected and which is suitable for transmitting images therebetween may be used. Cameras 30 may be either digital cameras for capturing images as still images in, for example, Joint Photographic Expert Group (JPEG) format. However, ideally, cameras 30 are standard analog video cameras, each camera 30 capturing analogue images as a respective video stream in National Television System Committee (NTSC) format.

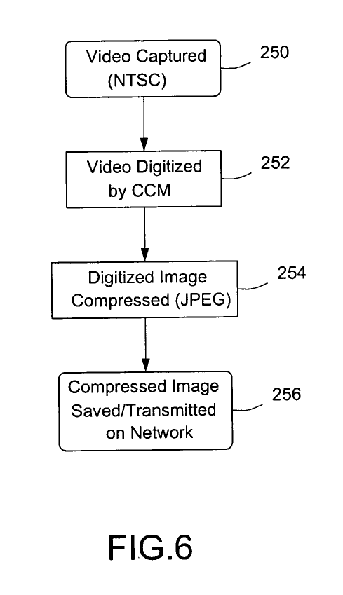

To better explain the method by which images are captured for surveillance, reference is now made to FIGS. 1 and 2, in conjunction with FIG. 6, a flow chart demonstrating the method by which images from NTSC video cameras 30 are captured and transmitted for system 10. Initially, at step 250, a respective NTSC video stream from each camera 30 is transmitted from camera 30 to CCM 28 over coaxial cable link 242. In response to an image capture request message received by CCM 28 over Echelon® network 48, CCM 28, at step 252, digitizes an image from video stream, i.e. a frame thereof, into a digitized image. The digitized image is then compressed by CCM 28, at step 254, into a compressed image in compressed image format, such as JPEG or the like. Compressed image is then, at step 256, sent over Echelon® network 48, using Echelon® protocol, to LCD 20, which then transmits the compressed image over Internet network 52 to ACD 38 or CLCD 42, where compressed image may be viewed by a user thereof and, if desired, saved. Optionally, compressed image may also be saved by CCM 28 to a CCM memory unit 224 installed on CCM 28, such as a flash memory card, disk drive, or the like. When compressed image is saved on CCM memory unit 244, the date and time that image was captured by CCM 28 is also saved in association therewith. Additionally, if image capture request is generated in relation to attempted use of an access document 80 in parking lot, the access identifier 82 associated therewith is transmitted over Echelon® network 48 to CCM 28 and may be saved in association with captured image on CCM memory unit 244, as well as on ACD 38 and CLCD 42.

CCM 28 can capture, save on CCM memory unit 224, and transmit across Echelon® network 48 one compressed image every 3 seconds, thus permitting a series of images from one camera 30 to be transmitted every three seconds to provide an image record of occurrences in parking lot. It should be noted that bandwidth provided by Echelon® network when implemented using Echelon® network links 58 consisting twisted pairs, namely 78 Kbps, is insufficient for transmitting NTSC video or an uncompressed digital video stream. Thus, digitization and compression of NTSC video stream into JPEG compressed images by CCM 28 advantageously allows conventional NTSC video cameras 30, used in many parking lots, to be readily adapted for use with system 10 on Echelon® Network where Echelon network links 58 are twisted pairs of wires. Otherwise, use of such NTSC video cameras 30 with Echelon® network across twisted pairs of wires would be difficult, if not impossible.

In general, image capture requests are automatically generated by an ACM 14 when vehicle sensor 74 detects a vehicle in proximity to the ACM 14, the image capture request designating the camera 30 closest to ACM 14. Similarly, image capture requests are also generated by ACM 14 when. a user presents access document 80 for reading by access document reading means, with the ACM 14 transmitting access identifier 82 associated with access document 80, and read by access document reading means, as part of image capture request. Also, should an alarm or assistance request be activated by a customer by using UI 22, UI 22 will also generate an image capture request. ACM 14 may also generate an image capture request if an irregularity is detected, such as gate 12 being moved into second position 18 without a vehicle being detected by vehicle sensor 74, in which case an alarm will also be generated and transmitted to attendant on ACD 38 and/or attendant telephone 54. Generally, when image capture request is generated in conjunction with an alarm or assistance request, images are captured at pre-determined intervals until an attendant deactivates the alarm. Generally, each camera 30 will be associated with a certain portion or zone of parking lot, with CCM 28 capturing image of camera 30 associated with zone in which the ACM 14 or UI 22 that generates the image capture request is associated. A specific camera 30 may also be designated as designated camera 30 in image capture request. Finally, it should be noted that image capture requests, designating designated camera, may also be sent from LCD 20. This latter situation is typically the case where a user, i.e. attendant or cluster administrator of respectively ACD 38 or CLCD 42 issues the request therefrom for viewing of image thereupon, the request being transmitted from ACD 38 or CLCD 42 to LCD 20 on Internet network 52 and then broadcast from LCD 20 to CCM 28 in Echelon® protocol over Echelon® network 48.

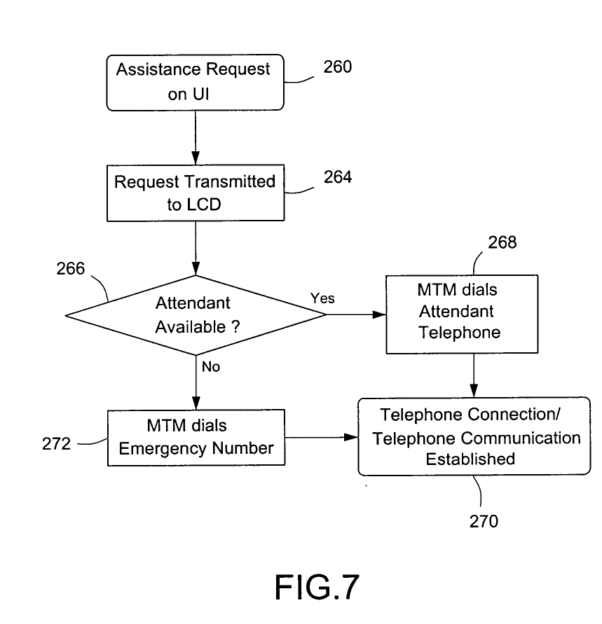

To aid the reader in understanding STM 34 and MTM 36, reference is now made to FIGS. 1 and 3, in conjunction with FIG. 7, a flowchart showing use of STM 34 and MTM 36 to establish telephone communication between customer and attendant. Commencing at 260, STM 34 is activated by a customer using UI 22, connected to STM 34 by an RS-232 link 262 providing an RS-232 bus connection therebetween, to make an assistance request. Next, at step 264, assistance request is transmitted from UI 22 to LCD 20 over Echelon network 48. In response to assistance request LCD 20 verifies, at step 266, whether an attendant is available. For example, LCD 20 may verify whether an attendant is connected to LCD 20 from ACD 38 using Internet network 52 and Echelon® network 48 with an attendant availability status indicating that attendant is available. However, a variety of other methods and or mechanisms may be deployed to determine availability of attendants. If an attendant is available, LCD 20, at step 268, instructs MTM 36 to dial the telephone number of attendant telephone 54 assigned to attendant that is available to establish a telephone connection therewith, using external telephone network 56, to allow customer to converse with attendant. Thus, at step 268, MTM 36 establishes telephone communication between customer at STM 34 connected on internal telephone network 50 and attendant using attendant telephone 54 on external telephone network 56. Using microphone 72 and speakers 74 on STM 34, customer can then, at step 270, engage in telephone communication with attendant who uses attendant telephone 54. If, at step 266, an attendant is not available, LCD 20 instructs MTM 36, at step 272, to dial an emergency telephone number, perhaps assigned to an emergency call center of attendants or for an attendant telephone of an attendant that has been assigned emergency duty. MTM 34 thus establishes a telephone communication between emergency telephone number, connected thereto over external telephone network 56, and STM 34, connected to MTM 36 over internal telephone network 50. Proceeding again to step 270, customer can then converse with attendant using attendant telephone 54 connected at emergency telephone number.

It should be noted that LCD 20 can also simultaneously cause to be sent, to the ACD 38 of attendant, information about the ACM 14 connected to UI 22 from which customer activates STM 32, UI 22 itself, status of parking lot, and customer derived from access rights record 84 associated with access identifier 82 of access document 80, if any, presented by customer. In addition, attendant may also consult RDB 46, and possibly LDB 44, using ACD 38, to obtain information on customer. In addition to telephone communication, STM 34 may play, using speakers 72, pre-recorded audio messages in response to audio message commands, which contain an audio message number associated with a given audio message, sent to STM 34 from LCD 20, ACM 14 or CRM 32 over Echelon® network 48. The audio messages are typically stored, in association with their respective audio message numbers, on audio message memory unit 280 of STM 34. Audio message memory unit 280 may be a disk drive, a removable flash memory card, or any other type of memory capable of storing audio files. Audio messages are typically created by recording audio on ACD 38 or CLCD 42 into a WAV audio file in WAV format, and then converting the WAV file into a compressed audio format in which audio is saved as audio message. Audio message is then transferred from ACD 38 or CLCD 42 to audio message memory unit 280. For example, if audio message memory unit 280 is a removable flash memory card, audio message memory unit 280 could be initially connected to ACD 38 or CLCD 42 for saving of audio messages thereupon, disconnected from ACD 38 or CLCD 42, and then connected to STM 34 to transfer audio messages thereto.

To aid the reader in better understanding databases LDB 34 and RDB 46, reference is again made to FIGS. 1, 2, and 4. RDB 44 contains all of the information stored in system 10 for identifying and processing use of every parking lot in a cluster by a customer. Typically RDB 44 is stored on a computing device which acts as a data base server, with all other CDs 38, 40, 42 acting as a client of the data base server. The database server may be a CLCD 42 or, preferably, a separate computing device dedicated to hosting the RDB 46. For the embodiment shown, the RDB 46 is implemented using Microsoft® SQL server, although any data base management software capable of transmitting information over internet network 52 may be used.

RDB 46 maintains and archives all access rights records 84 found on every LDB 46 of cluster of parking lots associated with RDB 46. Typically, each access rights record 84 in RDB 46 has at least one access identifier 82, such as credit card number or another alpha numeric string for RFID or a bar code, associated therewith and which serves to identify access rights record 84 in database 46. For example, an access rights record in RDB 46 could have a primary access identifier 82a and a number of associated secondary access identifiers 82b, all identifying the same access record 84. It should be noted that all access identifiers 82 must be unique. Each access rights record 84 designates a collection of access rights 86, and any amount due 100 associated therewith, for one or more parking lots in cluster, as well as one or more access documents 80 with which access identifiers 82 are inscribed. Any amount paid 304 for amount due 100 and the payment receiving means, i.e. CRM 32 or CCR 102, used to pay amount paid 304 is also stored as part of payment information 308 in access rights record 84. Access rights record 84 also stores access document type information 302, which details the various types of access documents 80, such as credit cards, RFID tags, or bar code documents, associated with access identifiers 82 for access rights record 84. When credit card is used to effect payment, credit card number and expiry date are also stored as part of payment information 308. These data elements 82, 86, 100, 302, 304, 308 are, typically, the minimum stored in RDB 46 in a given access rights record 84, such as in the case of a visitor, e.g. a customer who is not a subscriber, who obtains a bar code document as access document 80 in parking lot and pays amount due using CRM 32.

In addition, each access rights record 84 may contain personal information 306 such as the customer's address, telephone number, language preference, or the like. Further, access rights record 84 may also contain access document distribution information 300 indicating whether an access document 80 is to be distributed to a customer, as described previously, in parking lot or at another location and whether such access document 80 has, in fact, been distributed. In addition, payment information 308 may also contain, notably for subscribers: information relating to frequency of billing for access rights 86, i.e. frequency of calculation of amount due 100, whether amount due can be automatically paid by billing a given credit card number inscribed as part of payment information 308 with expiry date, history of payments, or the like. Reservations 322 of spaces in parking lots are also stored in access rights record 86 as part of access rights 86. RDB 46 also contains tariff information 126 for every parking lot in cluster, which is used by RDB 46 for calculating amount due, as well as invalid card list 132 of invalid credit card numbers.

Similar to RDB 46, LDB 44 also contains access rights record 84′, with each access rights record 84′ having at least one access identifier 82, such as credit card number or another alpha numeric string for RFID or a bar code, associated therewith and which serves to identify access rights record in LDB 44. LDB 44 generally also contains the data elements 82, 86, 100, 300, 302, 304 for access rights record 84′, as well as reservations 322 and access document distribution information 300 where applicable. The method by which payment is effected, using either cash with CRM 32 or CCR 102, is also stored on LDB 44 as payment information 308, including credit card number and expiry date when credit card is used to pay with CCR 102. LDB 44 only stores these data elements 82, 86, 100, 300, 302, 304, 308, 322 for the parking lot where LCD 20 to which LDB 44 is connected is situated. Accordingly, when changes are effected on RDB 46 to an access rights record 84, such as a creation or modification thereof and/or reservation 322 of a parking space, these changes are periodically transferred from RDB 46 to LDB 44 to effect changes in access rights record 84′ on LDB 44, thus synchronizing LDB 44 and RDB 46 with regard to data elements 82, 86, 100, 300, 302, 304, 308, 322. For example, reservations 322, as part of access rights 86, are regularly transferred, in association with access identifiers 82, from RDB 46 to LDB 44. LDB 44 also contains tariff information 126 for parking lot for calculating amount due 100, notably when this information is not provided by RDB 46 or is out of date. For example, when customer uses parking lot by obtaining a bar code document as access document 80 and has not previously had access rights 86 and access rights record 84′ created from CD 38, 40, 42 and entered in LDB 44, then access rights record 84′, including amount due 100 and any amount paid 304, will typically be initially entered by LCD 20 in LDB 44 and then subsequently transferred to RDB 46 for recording as a corresponding access rights record 84 therein. Further, even when access rights record 84′ in LDB 44 is transferred from access rights record 84 in RDB 86, such as in the case of a reservation 322, access rights 86 associated therewith, amount due 100, and amount paid 304 may have to be recalculated if use of parking lot by customer exceeds access rights 86 initially recorded in RDB 46. Once again, these modifications will be effected in LDB 44 to access rights record 84′ and then transferred to RDB 46 for storage in corresponding access rights record 84 therein. Typically, such updates from LDB 44 to RDB 46 occur on a periodic basis, say once per week, after which any information in access rights record 84′ on LDB 44 not required for ongoing use by LCD 20 and RDB 44, such as expired reservations 322, access document distribution information 300 for access documents 300 that have been distributed, and amounts paid 304, may be deleted from LDB 44. Entry and exit information stored in association with an access identifier 82 may also be deleted from LDB 44 once transferred to RDB 46. Like RDB 46, LDB 44 contains invalid card list 132, which is periodically updated from RDB 46.

LDB 44, for the embodiment shown is implemented using a scaled down version of MS-SQL server, MS-SQL (SMDE). However, as in the case of RDB 46, LDB 44 can be implemented in any database management system that can be queried and accessed form computing devices 38, 40, 42 over Internet network 52.

As RDB 46 archives information from LDB 44, by querying RDB 46 from ACD 38 or CLCD 42, an attendant or cluster administrator may therefore obtain information on all entries and exits from each parking lot administrated using RDB 46. Information on all amounts paid 304 as well as the payment receiving means used will similarly be accessible. As well, LCD 20 will also transfer information tracking each attendant access to LCD 20 and/or LDB 44 from ACD 36 to RDB 44, which also records each access to RDB 46 for security purposes.

Although the present invention has been described with a certain degree of particularity, it is to be understood that the disclosure has been made by way of example only and that the present invention is not limited to the features of the embodiments described and illustrated herein, but includes all variations and modifications within the scope and spirit of the invention as hereinafter claimed.

1. A system for controlling passage through at least one electronic gate of a parking lot, said system comprising:
at least one access control module connected to the gate and being adapted for controlling movement thereof for controlling passage therethrough;
a lot control device for controlling the access control module; and
a first network connecting said access control module and said lot control device, and by which said access control module and said lot control device communicate using Echelon® communication protocol.

2. The system of claim 1, wherein said lot control device comprises a first Neuron® microprocessor and said access control module comprises a second Neuron® microprocessor for providing communication in said Echelon® communication protocol over said first network.

3. The system of claim 1, wherein said lot control device is further connected to at least one computing device by a second network.

4. The system of claim 3, wherein said access control module is connected to at least one access document reading means for reading an access identifier inscribed on at least one access document of a customer of the parking lot, said access control module transmitting said access identifier to said lot control device, said lot control device authorizing and declining the passage through the gate upon receiving said access identifier.

5. The system of claim 4, wherein said lot control device is connected to a database comprising an access rights record for said customer, said access rights record comprising said access identifier and being identified thereby in said database by said lot control device, said access rights record defining access rights defining a right of a customer to pass through the gate and comprising an amount due for use of said access rights, said lot control device authorizing or declining the passage based on said access rights associated with said access identifier in said access rights record.

6. The system of claim 5, wherein said lot control device and said computing device are adapted for entering said access rights record in said database from said computing device.

7. The system of claim 6, further comprising payment receiving means for receiving a payment of said amount due.

8. The system of claim 7, wherein at least one of said computing device and said lot control device are connected to a credit card processing network for transmitting thereto a credit card number and a respective credit card expiry date for a credit card of said customer for processing of said payment by said credit card processing network.

9. The system of claim 8, further comprising a credit card reader connected to said access control module for receiving said credit card and for reading said credit card number upon presentation of said credit card to said credit card reader, said credit card number being transmitted from said credit card reader through said access control module to said lot control device.

10. The system of claim 9, wherein said payment receiving means comprises said credit card reader, said credit card reader further reading said respective expiry date, said respective expiry date being transmitted from said access control module with said credit card number to said lot control device and therefrom to said credit card processing network for processing of said payment.

11. The system of claim 9, wherein said access identifier is said credit card number, said access document is said credit card and said access document reading means is said credit card reader.

12. The system of claim 11, wherein said access rights record is received by said computing device by input by a user thereof and transmitted therefrom through said lot control device to said database prior to said presentation of said credit card by said customer.

13. The system of claim 7, wherein said access document reading means comprises at least one antenna and a radio frequency identifier reader connected to said antenna and to said access control module, said access document comprises a radio frequency identifier tag, and said access Identifier comprises a radio frequency identifier emitted by a transponder on said radio frequency identifier tag for reception by said antenna and reading by said radio frequency Identifier reader for transmission to said lot control device.

14. The system of claim 13, wherein said at least one access document comprises first and second access documents, said access rights record further comprises access document distribution information for authorizing distribution of said second access document, and said access control module is further connected to a radio frequency identifier writer for writing said radio frequency identifier to said transponder and a radio frequency identifier distributor for subsequently distributing said radio frequency identifier tag to said customer as said second access document, said first access document being read by said access document reading means, prior to said writing and said distributing of said second access document, for transmitting said access identifier to said lot control device, said lot control device authorizing said writing and said distributing of said second access document based on said access document distribution information.

15. The system of claim 3, further comprising a camera control means and at least one camera connected thereto for capturing at least one image of the parking lot and transmitting said image to said camera control means, said camera control means being further connected to said lot control device on said first network for subsequently transmitting said image thereto, said image being subsequently transmitted by said lot control device on said second network to said computing device for viewing thereupon.

16. The system of claim 15, wherein said image is transmitted from said camera control means to said lot control device using said Echelon® communication protocol.

17. The system of claim 16, wherein said camera is an analogue video camera for capturing said image as an analogue image.

18. The system of claim 17, wherein said camera control means comprises a microprocessor for converting said analogue image into a digital image and for compressing said digital image into a compressed image using a Joint Photographic Expert Group algorithm, said image transmitted from said camera control means to said lot control device being said compressed image.

19. The system of claim 18, wherein said microprocessor is a third Neuron® microprocessor.

20. The system of claim 19, wherein said camera control means is connected to said lot control device on said first network by a twisted pair of wires.

21. The system of claim 18, wherein said at least one image comprises a plurality of images which are compressed into a plurality of compressed images, and said camera control means comprises a memory unit in which said compressed images are stored.

22. The system of claim 21, wherein said analogue image is captured automatically by said camera, converted Into said digital image, and compressed into said compressed image at a predetermined time-interval, said compressed image being transmitted from said camera control means to said lot control device at said predetermined time interval.

23. The system of claim 21, wherein said compressed image is further transmitted, through said lot control device, from said camera control means to said computing device at said predetermined time interval, thereby updating said compressed image viewable by a user on said computing device at said pre-determined time interval.

24. The system of claim 1, wherein said access control module is connected to said lot control device on said first network by a twisted pair of wires.

25. The system of claim 1, further comprising at least one satellite telephony module situated in said parking lot and connectable to an attendant telephone monitored by an attendant for providing telephone communication between said customer and said attendant.

26. The system of claim 25, further comprising:
a master telephony module connected to said first network and to an external telephone network extending outside of said parking lot and to which said attendant telephone is connected; and
an internal telephone network situated within said parking lot and to which said master telephony module and said satellite telephony module are connected, said master telephony module connecting said satellite telephony module to said attendant telephone by said internal and said external telephone networks.

27. A method for controlling passage of a customer through a gate of a parking lot with an access control module connected to the gate and a lot control device connected to the access control module by a first network, said method comprising the steps of:
consulting an access rights record identified by an access identifier in a database connected to the lot control device, said access rights record comprising access rights defining a right of passage through the gate; and
after said consulting, controlling movement of the gate by said access control module based on said access rights to control passage through the gate.

28. The method of claim 27, further comprising the step of defining said access rights record, prior to said consulting, including specifying at least one said access identifier therefore and at least one access document encoding said access identifier, from a computing device connected to the lot control device by a second network.

29. The method of claim 28, further comprising the steps of, after said defining, and prior to said consulting:
reading said access identifier from said access document, as a first access document, with an access document reading means connected to the access control module, thereby identifying said access rights record; and
distributing a second access document to the customer, based on said access rights record, from a distributor connected to the access control module.

30. The method of claim 28, wherein said step of defining said access rights record comprises entry of a credit card number of a credit card into said database from said computing device, said credit card number being said access identifier and said credit card being said access document.

31. The method of claim 27, further comprising the steps of:
capturing an image of the parking lot with a video camera connected to a camera control means connected to said first network;
compressing said image with said camera control means into a compressed image; and
transmitting said compressed image over twisted pairs of wires of said first network from said camera control means to the lot control device using Echelon® protocol.

32. The method of claim 31, further comprising the step of, after said transmitting to the lot control device, transmitting said compressed image from the lot control device to a computing device connected thereto by a second network for viewing of said compressed image from said computing device.
